(19) United States
(12) Patent Application Publication
(10) Pub. No.: US 2006/0010683 A1
(43) Pub. Date: Jan. 19, 2006

(54) Method of manufacturing ignition coil filled with resin

(75) Inventors: Atsushi Iwami, Susono-city (JP); Tetsuya Miwa, Nagoya-city (JP); Koji Miyachi, Ama-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/171,222

(22) Filed: Jul. 1, 2005

(30) Foreign Application Priority Data
Jul. 16, 2004 (JP) 2004-209722

(51) Int. Cl. H01F 27/02

(52) U.S. Cl. 29/602.1; 336/90; 29/605

(57) ABSTRACT

An ignition coil for supplying a high voltage to a spark plug is mainly composed of a cylindrical casing, an outer coil wound around an outer spool and an inner coil wound around an inner spool. The outer coil wound around the outer spool and the inner coil wound around the inner spool are coaxially disposed in the cylindrical casing. Spaces in the cylindrical casing including a first space between the inner coil and the outer spool and a second space between the outer coil and the cylindrical casing are filled with insulating resin. After the resin is supplied into the cylindrical casing, the coils are inserted into the casing containing the resin therein. Accordingly, the resin can be quickly supplied from a wide opening, and the resin can enter into spaces between coils even these spaces are small.

### CROSS-REFERENCE TO RELATED APPLICATION

This application is based upon and claims benefit of priority of Japanese Patent Application No. 2004-209722 filed on Jul. 16, 2004, the content of which is incorporated herein by reference.

### BACKGROUND OF THE INVENTION

1. Field of the Invention

The present invention relates to a method of manufacturing an ignition coil for igniting an internal combustion engine.

2. Description of Related Art

An ignition coil having a primary coil, a secondary coil and a magnetic core contained in a casing is conventionally manufactured by supplying thermoplastic resin into the casing in which the components are already contained, as exemplified in JP-A-2003-318056. On the other hand, an ignition coil directly connected to a spark plug and ignition coil integrally formed with a spark plug have been proposed. Further, a space available for an ignition coil is becoming smaller due to requirements for downsizing an engine or for installing two plugs to each cylinder. Therefore, it has been strongly required to make an ignition coil small in size.

In a small-sized ignition coil, insulating resin has to be supplied into the casing through a small opening. Further, it has been proposed to cover either one of a primary coil or a secondary coil with resin (potting with resin) to reduce stress imposed on components of a small-sized ignition coil. In this case, the resin has to be supplied only to an outer circumference of one of the coils through a small opening. A considerably long time is required to supply the resin through a small opening. Sometimes, it has been difficult to supply the resin only to limited portions through a small opening.

### SUMMARY OF THE INVENTION

The present invention has been made in view of the above-mentioned problems, and an object of the present invention is to provide a method of manufacturing an ignition coil, in which insulating resin is easily supplied even when resin-potting is required only for limited portions.

The ignition coil includes a cylindrical casing, an outer coil functioning as a primary coil, and an inner coil functioning as a secondary coil. The outer coil is wound around a cylindrical outer spool, and the inner coil is wound around cylindrical inner spool. The outer coil wound around the outer spool and the inner coil wound around the inner spool are coaxially disposed in the cylindrical casing. An inner space of the cylindrical casing including a first space between the inner coil and the outer spool and a second space between the outer coil and the cylindrical casing is filled with thermosetting insulating resin. Alternatively, either the first space or the second space may be filled with the resin if such is advantageous to avoid additional stress imposed on the components of the ignition coil.

The ignition coil is manufactured in the following process. First, a plug cap and other components are connected to the cylindrical casing, forming a case unit, and the inner coil wound around the inner spool is inserted into the outer spool around which the outer coil is wound, forming a coil unit. Then, a predetermined amount of liquid state resin is supplied into the cylindrical casing. Then, the coil unit is inserted into the cylindrical casing containing the resin therein. The liquid state resin contained in the cylindrical casing is pushed up, filling the inner space of the cylindrical casing including the first space and the second space. Finally, the coil assembly is heated to harden the resin filling the inner space of the cylindrical casing.

Preferably, the steps of supplying the resin into the cylindrical casing and inserting the coil unit are performed under a vacuum atmosphere to avoid generation of voids in the resin. An additional resin may be added after the coil unit is inserted into the cylindrical casing to supply sufficient amount of the resin to the inner space. A viscosity of the liquid state resin is set in an adequate range, e.g., 0.3-1.35 Pa·S, and a diameter of a nozzle for supplying the resin is made larger than 1.0 mm. The inner spool and the outer spool are formed so that the resin is supplied only to desired spaces, i.e. both of the first and the second spaces, or either one of the spaces.

According to the present invention, an opening for supplying the resin can be made sufficiently large because the coil unit is inserted into the cylindrical casing after the resin is supplied to the casing. Therefore, the resin-supplying step can be easily and quickly performed. Further, only the desired portions in the cylindrical casing can be filled with the resin by forming the spools in a proper shape. The desired spaces are surely filled with the resin even the spaces are small, because the coil unit is inserted into the cylindrical casing in which the liquid state resin is already contained. The present invention is similarly applicable to an ignition device having a spark plug integrally connected to an ignition coil.

Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing an ignition coil as a first embodiment of the present invention;

FIG. 2 is a cross-sectional view showing a process of supplying resin into a cylindrical casing;

FIG. 3A is a cross-sectional view showing a coil unit to be inserted into an inner bore of the cylindrical casing;

FIG. 3B is a cross-sectional view showing the casing in which a predetermined amount of resin is contained;

FIG. 4 is a cross-sectional view showing an ignition coil as a second embodiment of the present invention;

FIG. 5 is a cross-sectional view showing an ignition coil integrally formed with a spark plug as a third embodiment of the present invention; and

FIG. 6 is a cross-sectional view showing an ignition coil as a fourth embodiment of the present invention.

### DETAILED DESCRIPTION OF THE PREFERRED EMBODIMENTS

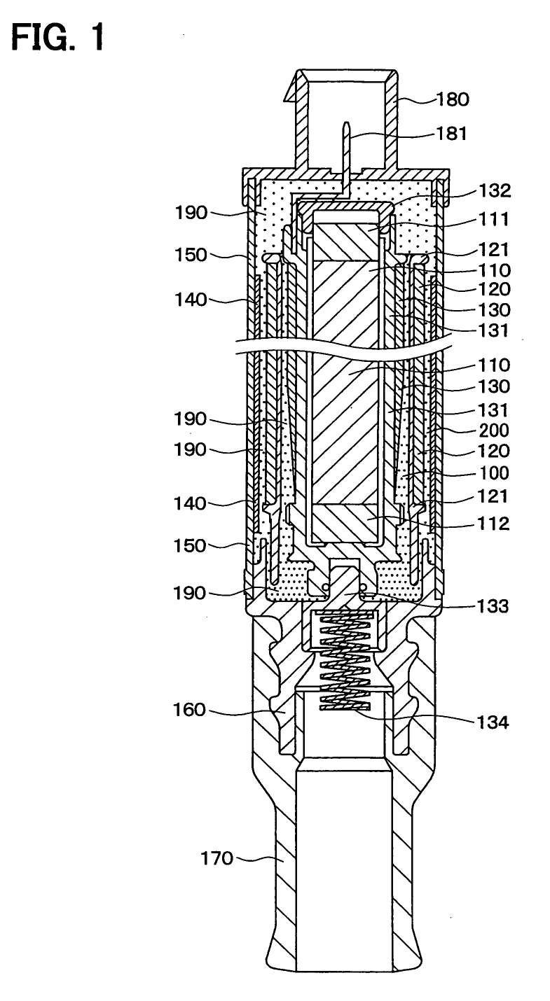

A first embodiment of the present invention will be described with reference to FIGS. 1-3B. An ignition coil shown in FIG. 1 is used for supplying a high voltage (e.g., 30 kV) to a spark plug installed in a cylinder of an internal combustion engine. The ignition coil is formed in a rod-like shape and directly connected to an insulator of a spark plug.

As shown in FIG. 1, an elongate center core 110 made of silicon steel is positioned in the center of the ignition coil. Permanent magnets 111, 112, each having a polarity opposite to a polarity induced by an outer coil 120 (functioning as a primary coil), are positioned at both longitudinal ends of the center core 110. An inner coil 130 functioning as a secondary coil is disposed outside the center core 110. The inner coil 130 is wound around a cylindrical inner spool 131 made of an insulating resin material such as PPE. The bottom end of the cylindrical inner spool 131 is closed and the open top end thereof is closed with a cap 132. The center core 110 and the permanent magnets 111, 112 are disposed in the cylindrical inner spool 131.

A high voltage of the inner coil 130 is electrically connected to a spark plug (not shown), which is coupled to a plug cap 170, through a high tension terminal 133 and a spring 134 made of a conductive material. A low voltage side of the inner coil 130 is electrically connected to an on-board direct current power source or the ground. An outer coil 120 functioning as a primary coil is disposed outside the inner coil 130. The outer coil 120 is wound around a cylindrical outer spool 121 made of an insulating resin material such as PPE. A primary current is intermittently supplied to the outer coil 120 based on signals from an ignitor (not shown), and a high voltage is induced in the inner coil 130.

A cylindrical outer core 140 made of silicon steel or the like is disposed outside the outer coil 120. A cylindrical casing 150 made of a resin material such as PPS is disposed outside the outer core 140. A high tension tower 160 made of a resin material in a stepped cylindrical shape is fixedly connected to the bottom end of the cylindrical casing 150. A high tension terminal is fixedly inserted into a center hole of the high tension tower 160. The bottom end of the cylindrical casing 150 is closed with the high tension tower 160 and the high tension terminal 133. A cylindrical plug cap 170 made of a resin material is fixedly connected to a high tension tower 160 sticking out of the casing 150.

A cylindrical connector 180 made of resin is connected to the top end of the casing 150, thereby closing the top end of the casing 150. A terminal 181 for supplying a primary current to the outer coil 120 is positioned in the connector 180. The inner space of the casing 150, including a first space 100 between the inner coil 130 and the outer spool 121 and a second space 200 between the outer coil 120 and the outer core 140, is filled with insulating resin 190. Thermosetting epoxy resin is used as the insulating resin 190.

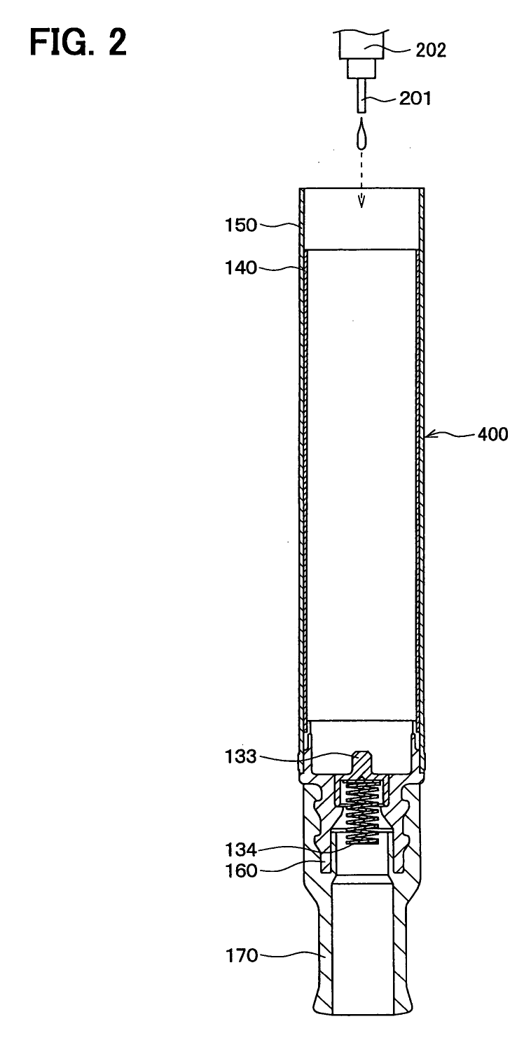

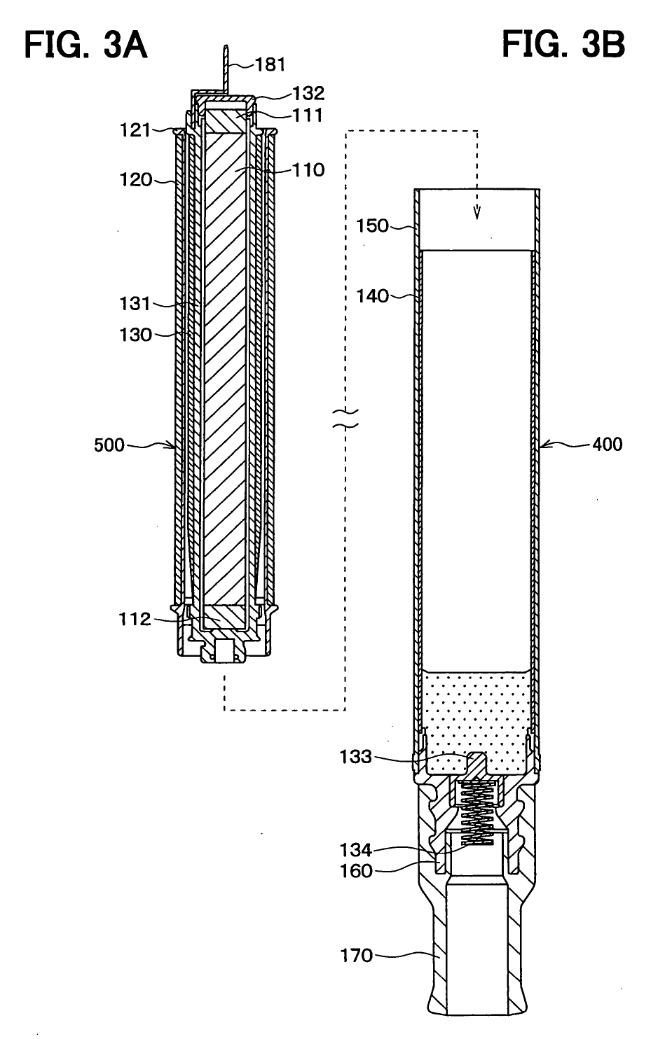

Now, a process of manufacturing the ignition coil will be described. As shown in FIG. 2, the high tension terminal 133, the spring 134, the outer core 140, the casing 150, the high tension tower 160 and the plug cap 170 are connected to one another, forming a case unit 400. On the other hand, the center core 110, the inner coil 130 wound on the inner spool 131, the outer coil 120 wound on the outer spool 121, permanent magnets 111, 112, the cap 132 and the terminal 181 are all assembled as shown in FIG. 3A, forming a unitary coil unit 500.

Then, as shown in FIG. 2, a predetermined amount of the insulating resin in a liquid state is supplied into the case unit 400 from a nozzle 201 of a resin-supplying device 202. The diameter of the nozzle 201 is made larger than 1.0 mm, and the liquid state resin is kept at a temperature of 70° C. A viscosity of the resin at 70° C. is in a range of 0.30-1.35 Pa·S.

Then, as shown in FIGS. 3A and 3B, the coil unit 500 is inserted into the inner bore of the case unit 400 in which the liquid state resin is contained at its bottom end portion. By inserting the coil unit 500, the resin located at the bottom portion of the case unit 400 is pushed up, and the inner space of the casing 150 including the first space 100 and the second space 200 is filled with the resin. The amount of the resin supplied to the case unit 400 is determined so that the first space 100 and the second space 200 are fully filled with the resin. In order to avoid generation of voids in the resin, the process of supplying resin into the case unit 400 and the process of inserting the coil unit 500 are performed under a vacuum atmosphere.

After the coil unit 500 is inserted into the case unit 400, the ignition coil is heated to harden the thermosetting resin 190 filling the inner space of the casing 150. Thus, the process of manufacturing the ignition coil shown in FIG. 1 is completed.

The opening of the case unit 400 for supplying the resin can be made sufficiently large since the resin is supplied into the casing 150 before the coil unit 500 is inserted into the casing 150. Therefore, the liquid state resin can be quickly supplied into the casing 150. The inner spool 131, both longitudinal ends of which are closed, is inserted into the case unit 400. Therefore, the resin does not enter into an inner bore of the inner spool 131 even when the resin is pushed up above the top end of the inner spool 131. This is advantageous when supply of the resin into the inner bore of the inner spool 131 is not desired.

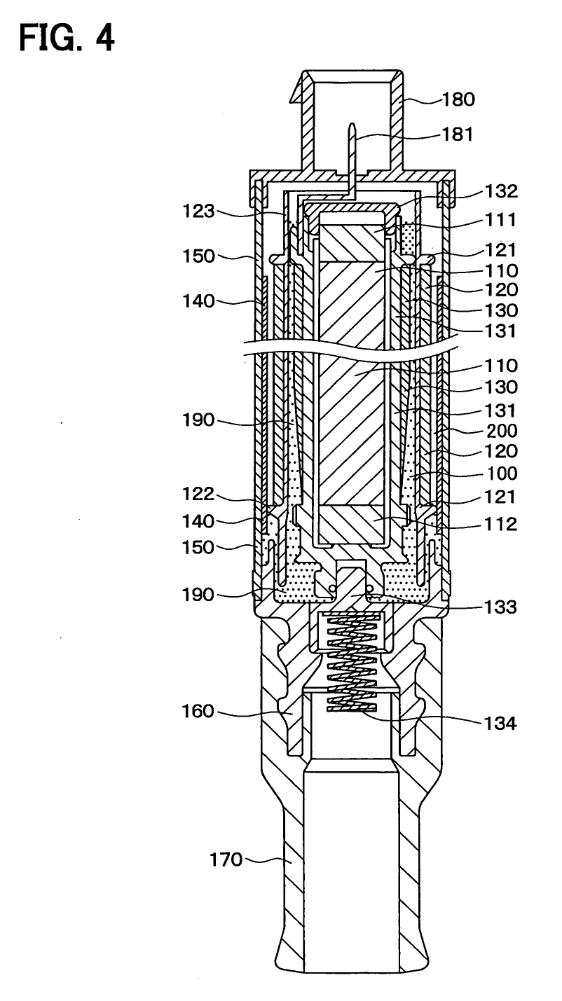

A second embodiment of the present invention will be described with reference to FIG. 4. The second embodiment is similar to the first embodiment described above, except that only the first space 100 between the inner coil 130 and the outer spool 121 is filled with the resin 190 while keeping the second space 200 unfilled. In other words, in the second embodiment, resin-potting is applied only to the inner coil 130.

As shown in FIG. 4, a circular flange 122 contacting the outer core 140 is formed on a bottom portion of the outer spool 121. Further, a cylindrical wall 123 extending above the cap 132 is additionally formed at the top end of the inner spool 121. The second embodiment is manufactured in the same manner as the first embodiment. In the process of inserting the coil unit 500 into the case unit 400 containing the liquid state resin, the resin is pushed up in the same manner as in the first embodiment. However, the resin 190 is prevented by the circular flange 122 from further flowing up beyond the circular flange 122. Further, the resin overflowing from the top end of the first space 100 is prevented from entering into the second space 200 by the extended cylindrical wall 123. Therefore, the resin 190 is not supplied to the second space 200, while filling the first space 100 with the resin 190 in the same manner as in the first embodiment.

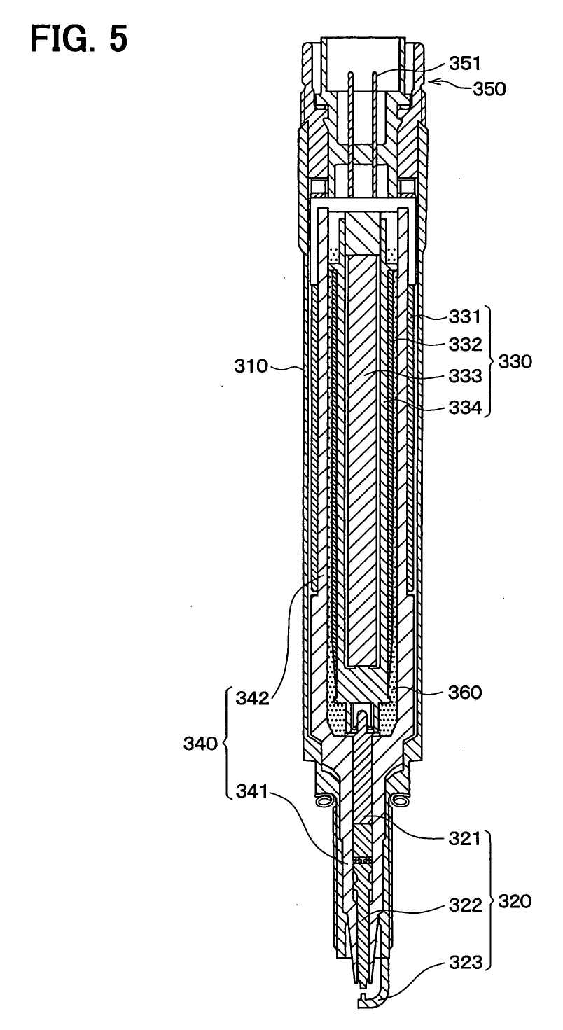

A third embodiment of the present invention will be described with reference to FIG. 5. An ignition device shown in FIG. 5 includes a spark plug 320 and an ignition coil 330, both being integrally formed. The spark plug 320 and the ignition coil 330 are contained in a common cylindrical casing 310. The ignition device is installed in a cylinder head of an internal combustion engine, so that the spark plug 320 exposes to a combustion chamber of the engine.

The casing 310 is made of a metallic material that is conductive and magnetic, such as S45C or SUS430. A cylindrical ceramic insulator 340 integrally forming a plug insulator 341 and an outer spool 342 is inserted in the casing 310. An outer coil 331 functioning as a primary coil is wound on the outer spool 342. The spark plug 320 includes a metallic stem 321, a center electrode 322 made of a conductive material and a ground electrode 323 made of a conductive material. The metallic stem 321 and the center electrode 322 are inserted into a center hole of the plug insulator 341, and a tip portion of the center electrode 322 exposes to the combustion chamber. The ground electrode 323 is connected to the casing 310 by welding or the like to face the center electrode 322 with a certain spark gap apart therefrom.

The ignition coil 330 includes an outer coil 331 functioning as a primary coil wound on an outer spool 342, an inner coil 332 functioning as a secondary coil wound on an inner spool 334, and a center core 333 made of a magnetic material in a pillar shape. The inner spool 334 is made of insulating resin in a cylindrical shape having a closed bottom end. The outer coil 331 is electrically connected to terminals 351 positioned in a connector 350. A primary current is supplied to the outer coil 331 from the terminals 351 based on signals from an ignitor (not shown).

The center core 333, the inner coil 332 wound on the inner spool 334 and the outer coil 331 wound on the outer spool 342 are coaxially disposed in the cylindrical casing 310. A space between the inner coil 332 and the outer spool 342 is filled with resin 360. The resin 360 is insulating resin such as thermosetting epoxy resin. A high voltage end of the inner coil 332 is electrically connected to the center electrode 322 through the metallic stem 321, and its low voltage end is electrically connected to the casing 310 through a terminal (not shown). The casing 310 is grounded to a vehicle body through the cylinder head. A high voltage generated in the inner coil 332 is discharged through the spark gap between the center electrode 322 and the ground electrode 323, and thereby mixture in the combustion chamber is ignited.

Now, a process of manufacturing the ignition device shown in FIG. 5 will be described. The ceramic insulator 340, on which the outer coil 331 is wound and to which the metallic stem 321 and the center electrode 322 are connected, is inserted into the cylindrical casing 310 to which the ground electrode 323 is connected. Thus, a case unit as an integral body is formed. On the other hand, an inner spool unit is formed by winding the inner coil 334 around the inner spool 334 and inserting the center core into the inner spool 334.

Then, liquid state resin is supplied into the case unit, i.e., into the inner bore of the ceramic insulator 340 from a resin-supplying device. A predetermined amount of the liquid state resin is contained in a bottom portion of the case unit. Then, the inner spool unit is inserted into the case unit. By inserting the inner spool unit, the resin contained in the bottom portion of the case unit is pushed up and flows into the space between the inner coil 332 and the outer spool 342. The amount of resin supplied to the case unit is determined so that the resin does not overflow the outer spool 342, while fully filling the space between the inner coil 332 and the outer spool 342. Thus, only the inner coil 332 is potted with the resin, and the outer coil 331 is kept free from the resin. Then, the connector 350 is fixedly connected to the casing 310, closing the upper opening of the casing 310. In order to avoid generation of voids in the resin 360, the process of supplying resin into the case unit and the process of inserting the inner spool unit are performed under a vacuum atmosphere.

Then, the resin 360 filling the space between the inner coil 332 and the outer spool 342 is hardened by heating the assembled ignition device. Thus, the process of manufacturing the ignition device shown in FIG. 5 is completed.

Since the liquid state resin is supplied into the case unit from an open upper end thereof, the resin-supplying process can be performed in a short period of time. Since the inner spool unit having a closed bottom is inserted into the resin contained in the case unit, the resin does not enter into the inner bore of the inner spool 334. This is advantageous when potting of the inner bore of the inner spool 334 is not desired.

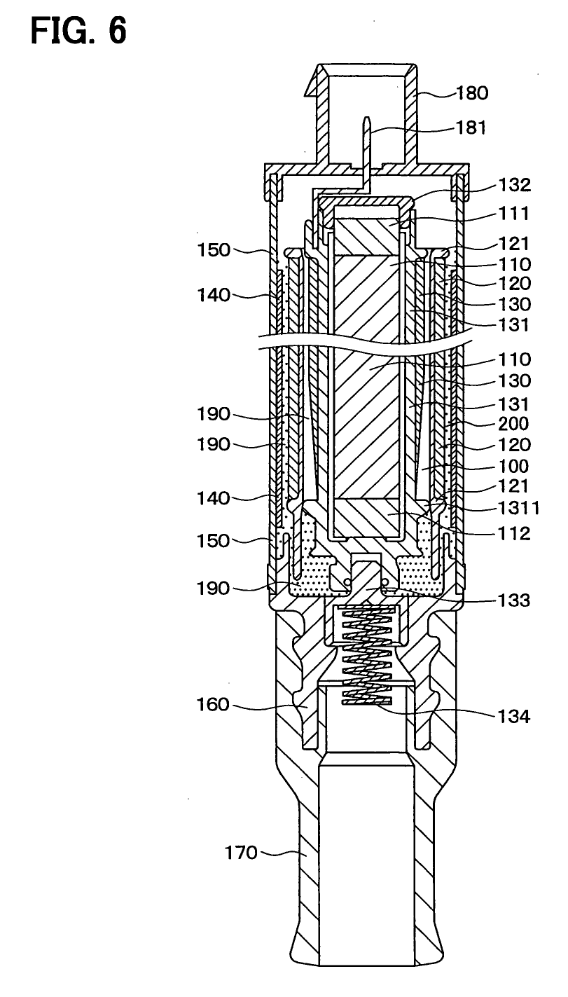

A fourth embodiment of the present invention will be described with reference to FIG. 6. The fourth embodiment is similar to the first embodiment, except that only the second space 200 between the outer coil 120 and the outer core 140 is filled with the resin while leaving the first space 100 unfilled.

The process of inserting the coil unit into the case unit is performed in the same manner as in the first embodiment. To prevent the resin 190 from flowing into the first space 100, a circular projection 1311 contacting the outer spool 121 is formed around the outer surface of the inner spool 131. The resin pushed up by inserting the coil unit into the case unit is stopped at the circular projection 1311. The first space 100 is kept free from the resin while the second space 200 is sufficiently filled with the resin. Other process of manufacturing the fourth embodiment is the same as that of the first embodiment.

The present invention is not limited to the embodiments described above, but it may be variously modified. For example, though the secondary coil is disposed inside and the primary coil is disposed outside in the foregoing embodiments, their relative positions in the cylindrical casing may be reversed. The amount of resin to be supplied in the casing is predetermined in the foregoing embodiments. However, a certain amount of resin may be supplied into the casing in the resin-supplying process, and an additional amount of resin may be supplied after the coil unit is inserted so that a total amount of resin becomes adequate. It is also possible to supply the resin in the following manner: inserting the outer spool 121 on which the outer coil 120 is wound into the case unit 400 containing the resin; then supplying some more resin into the outer spool 121; and then inserting the inner spool 131 on which the inner coil 130 is wound into the outer spool 121.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A method of manufacturing an ignition coil having a cylindrical casing, an outer coil wound on a cylindrical outer spool, and an inner coil wound on a cylindrical inner spool, both of the outer coil and the inner coil being coaxially disposed in the cylindrical casing, the method comprising:
supplying a predetermined amount of resin into an inner space of the cylindrical casing; and then inserting the outer coil and the inner coil into the cylindrical casing, so that the resin contained in the cylindrical casing flows into either a first space between the inner coil and the outer spool or a second space between the outer coil and the cylindrical casing, or both spaces, thereby filling those spaces with the resin.

2. The method of manufacturing an ignition coil as in claim 1, wherein:
the cylindrical outer spool includes a circular flange contacting an inner bore of the cylindrical casing; and
in the inserting step, a resin flow into the second space is prevented by the circular flange, while permitting a resin flow into the first space.

3. The method of manufacturing an ignition coil as in claim 1, wherein:
the cylindrical inner spool includes a circular projection contacting an inner bore of the cylindrical outer spool; and
in the inserting step, a resin flow into the first space is prevented by the circular projection, while permitting a resin flow into the second space.

4. The method of manufacturing an ignition coil as in claim 1, wherein:
the resin is thermosetting resin which is hardened after filling either the first or the second space, or both spaces

5. The method of manufacturing an ignition coil as in claim 1, wherein:
the resin-supplying step and the inserting step are performed under a vacuum atmosphere.

6. The method of manufacturing an ignition coil as in claim 1, wherein:
the method further includes a step of supplying additional amount of resin into the spaces to be filled with the resin, this step being performed after the inserting step.

7. The method of manufacturing an ignition coil as in claim 1, wherein:
a bottom end of the inner spool is closed; and
a center core made of a magnetic material is disposed in the inner spool.

8. The method of manufacturing an ignition coil as in claim 1, wherein:
a viscosity of the resin is in a range of 0.3-1.35 Pa·S when the resin is supplied into the cylindrical casing.

9. A method of manufacturing an ignition coil having a cylindrical casing, an outer coil wound on a cylindrical outer spool, and an inner coil wound on a cylindrical inner spool, both of the outer coil and the inner coil being coaxially disposed in the cylindrical casing, the method comprising:
positioning the cylindrical outer spool on which the outer coil is wound in the cylindrical casing; then supplying a predetermined amount of resin into an inner space of the cylindrical outer spool; and then inserting the inner spool on which the inner coil is wound into the outer spool, so that the resin contained in the outer spool flows into a space between the inner coil and the outer spool, thereby filling the space with the resin.

10. The method of manufacturing an ignition coil as in claim 9, wherein:
the resin is thermosetting resin which is hardened after filling the space between the inner coil and the outer spool.

11. The method of manufacturing an ignition coil as in claim 9, wherein:
the resin-supplying step and the inserting step are performed under a vacuum atmosphere.

12. The method of manufacturing an ignition coil as in claim 9, wherein:
the method further includes a step of supplying additional amount of resin into the space between the inner coil and the outer spool, this step being performed after the inserting step.

13. The method of manufacturing an ignition coil as in claim 9, wherein:
a bottom end of the inner spool is closed; and
a center core made of a magnetic material is disposed in the inner spool.

14. The method of manufacturing an ignition coil as in claim 9, wherein:
a viscosity of the resin is in a range of 0.3-1.35 Pa·S when the resin is supplied into the cylindrical outer spool.
